(19) United States
(12) Patent Application Publication
(10) Pub. No.: US 2016/0118753 A1
(43) Pub. Date: Apr. 28, 2016

(54) SEMICONDUCTOR MEMORY DEVICE

(71) Applicant: KABUSHIKI KAISHA TOSHIBA, Minato-ku (JP)

(72) Inventors: Takeshi IKUTA, Yokohama (JP); Yuuta YAMADA, Yokohama (JP)

(73) Assignee: KABUSHIKI KAISHA TOSHIBA, Minato-ku (JP)

(21) Appl. No.: 14/844,409

(22) Filed: Sep. 3, 2015

(30) Foreign Application Priority Data
Oct. 28, 2014 (JP) 2014-219215

(51) Int. Cl. H01R 13/66; H01R 13/52

(52) U.S. Cl. CPC H01R 13/665; H01R 13/5202

(57) ABSTRACT

According to one embodiment, a semiconductor memory device includes: a substrate including a memory capable of storing data and a controller controlling the memory, and a housing including first and second housing parts and holding the substrate therein. The first housing part includes a fixing unit which has elasticity and is in contact with the substrate.

### CROSS-REFERENCE TO RELATED APPLICATIONS

This application is based upon and claims the benefit of priority from Japanese Patent Application No. 2014-219215, filed Oct. 28, 2014, the entire contents of which are incorporated herein by reference.

### FIELD

Embodiments described herein relate generally to a semiconductor memory device.

### BACKGROUND

In recent years, as a detachable storage medium used for electronic devices such as personal computers (PC), a Universal Serial Bus (USB) memory device which is embedded with a flash memory and is provided with a USB connector is known.

### BRIEF DESCRIPTION OF THE DRAWINGS

FIGS. 1 and 2 are a perspective view and an exploded view of a semiconductor storage device according to a first embodiment;

FIGS. 3 and 4 are cross-sectional views taken along lines A-A and B-B of the semiconductor storage device according to the first embodiment;

FIG. 5 is a diagram showing a fixing unit 3 in contact with a substrate 10 of narrow width in the semiconductor storage device according to the first embodiment;

FIG. 6 is a diagram showing the fixing unit 3 in contact with the substrate 10 of wide width in the semiconductor storage device according to the first embodiment;

FIGS. 7 to 10 are cross-sectional views taken along line A-A of a semiconductor storage device according to first to forth examples of a second embodiment;

FIGS. 11 to 13 are cross-sectional views taken along line B-B of a semiconductor storage device according to first to third examples of a third embodiment; and

FIGS. 14 and 15 are a perspective view and an exploded view of a semiconductor storage device according to a first example of a modified example.

### DETAILED DESCRIPTION

In general, according to one embodiment, a semiconductor memory device includes a substrate and a housing. The substrate includes a memory capable of storing data and a controller controlling the memory. The housing includes first and second housing parts and holds the substrate therein. The first housing part includes a fixing unit which has elasticity and is in contact with the substrate.

### 1. First Embodiment

A semiconductor storage device according to a first embodiment will be described. Hereinafter, an example of a USB memory device will be explained as the semiconductor storage device.

### 1.1 USB Memory Device Configuration

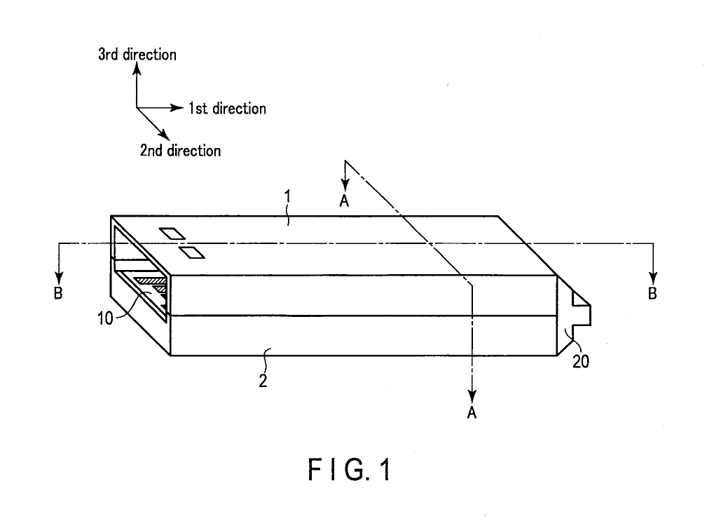

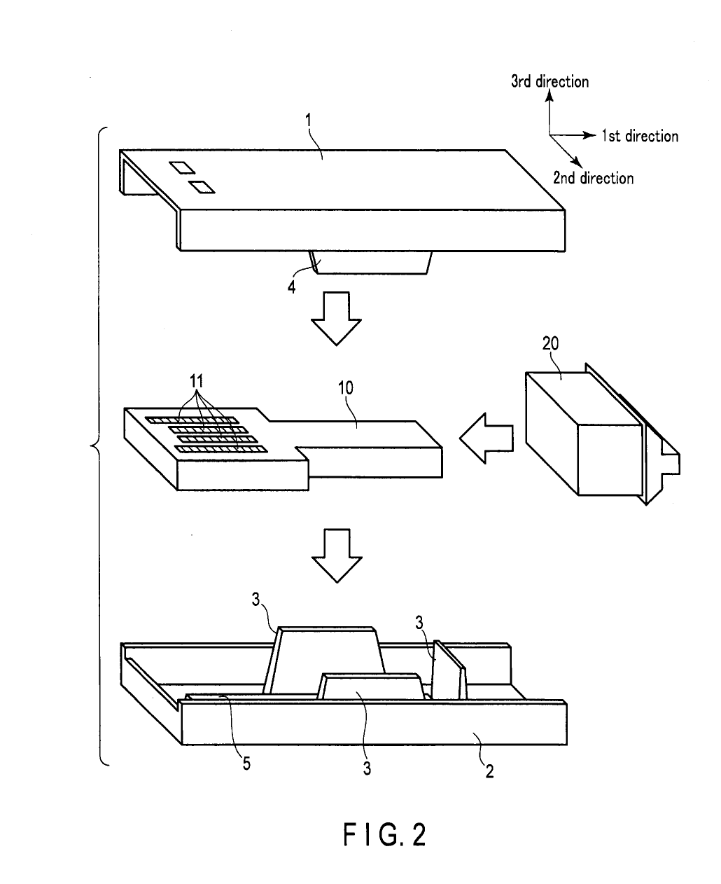

The configuration of the USB memory device according to the present embodiment will be explained using FIG. 1 and FIG. 2. FIG. 1 is a perspective view of the USB memory device according to the present embodiment, and FIG. 2 is an exploded view of the USB memory device shown in FIG. 1.

As shown in FIG. 1 and FIG. 2, the USB memory device includes a substrate 10, a housing part 1, a housing part 2, and a sealing member 20.

The substrate 10 includes four terminals 11 on its upper surface. The substrate 10 further includes on an underside surface thereof, for example, a memory, controller and semiconductor element (a passive element such as a resistor or a capacitor and/or an active element such as a transistor), and a circuit connected thereto (not shown in the drawings). The substrate 10 further includes a sealing resin for protecting the memory, the controller, the semiconductor element and the circuit. The substrate 10 may also be, for example, a printed circuit board (PCB).

The memory is, for example, a NAND type flash memory. The controller controls this memory. The memory and the controller may be formed on, for example, one semiconductor chip, or may be on separate independent semiconductor chips. In the case where the memory and the controller are formed on separate semiconductor chips, they may be an SiP (system in a package), in which they are put in one package.

The terminal 11 electrically connects an USB memory device with an external device (host device). The four terminals 11 include a terminal for receiving source voltage, a terminal for transmitting and receiving a control signal and data, and a terminal for receiving a reference potential (for example, a ground potential) from an external device. The number of terminals 11 is not limited to four, and therefore may be three or less, or five or more.

The housing parts 1 and 2 are formed of, for example, an insulating resin. A housing is formed by combining the housing parts 1 and 2. The housing holds the substrate 10 and a part of the sealing member 20 therein. When the housing is connected to an external device, one end of the housing is inserted into an USB port of the external device, which allows the terminals 11 to be electrically connected with the external device.

The housing part 2 has a fixing unit 3 and a pedestal 5 therein for fixing the substrate 10. The housing part 1 has a support unit 4 therein for supporting the fixing unit 3. Hereinafter, regarding the housing parts 1 and 2, the parts and surfaces forming the inside (or inner side) of the housing will be defined as inside (or inner side) of the housing parts 1 and 2.

The pedestal 5 is formed of, for example, an insulating resin, on the upper surface of which the substrate 10 is arranged.

The fixing unit 3 has elasticity and is formed of, for example, an insulating resin.

The support unit 4 is formed of, for example, an insulating resin.

When the housing parts 1 and 2 are combined, the support unit 4 comes in contact with the fixing unit 3 and pushes the fixing unit 3 towards the substrate. In this manner, the fixing unit 3 deforms towards the substrate and comes in contact with the substrate 10. As a result, the substrate 10 is held by the fixing unit 3 and has its position fixed in the housing.

The sealing member 20 is formed of, for example, an insulating resin. The sealing member 20 has a part of it inserted into the housing to seal the other end of the housing (the side opposite to the side inserted into the USB port).

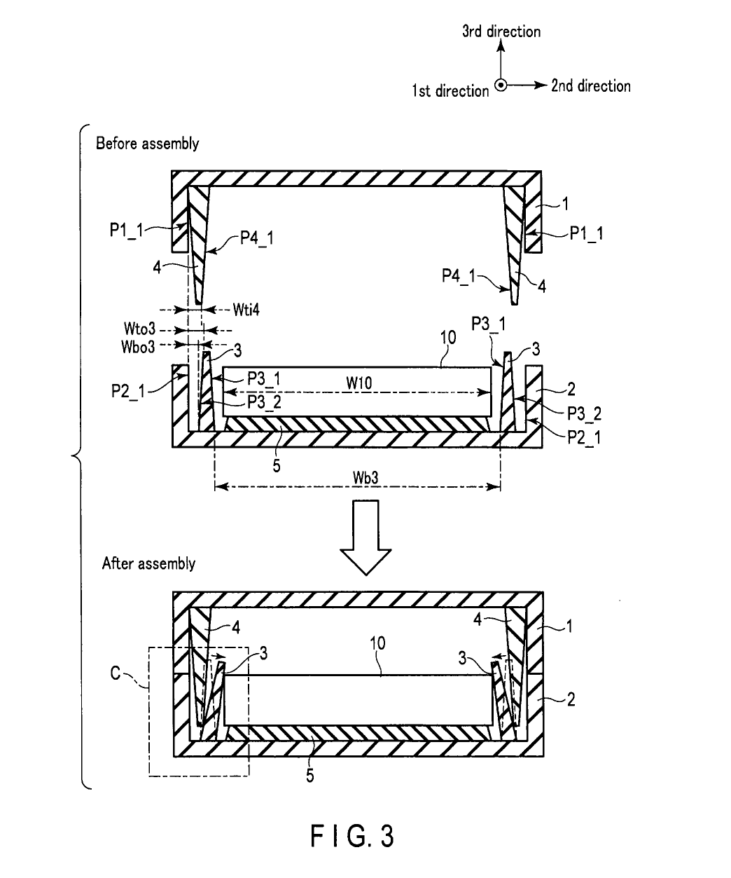

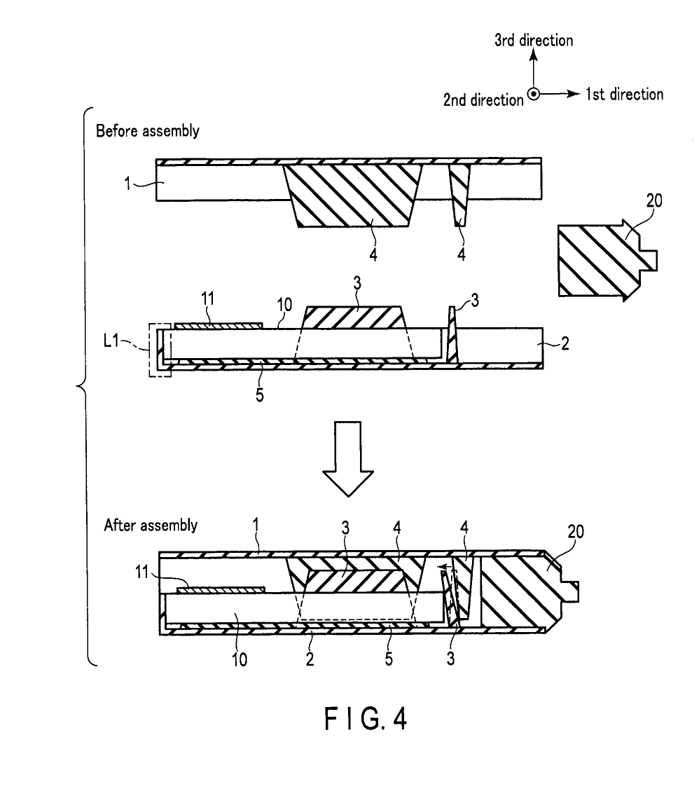

The aspect of the fixing unit 3 fixing the substrate 10 upon assembling the USB memory device is explained in further detail using FIG. 3 and FIG. 4. In the following explanation using FIG. 3, the left side of the drawing along a second direction will be defined as the left side of the USB memory device, and the right side of the drawing along the second direction will be defined as the right side of the USB memory device. In FIG. 4, the left side of the drawing along a first direction will be defined as the front side of the USB memory device, and the right side of the drawing along the first direction will be defined as the rear side of the USB memory device.

As shown in FIG. 3, the back side of the substrate 10 is in contact with the pedestal 5. The fixing unit 3 has a trapezoidal cross-sectional surface and is arranged on each of the left and right outer side of the substrate 10, that is, between the substrate 10 and the side surface of the housing part 2. The spacing between the two fixing units 3 arranged on the left and right sides is such that, for example, when the bottom part of surfaces of the two fixing units 3 facing each other (in FIG. 3, a surface indicated by reference symbol P3_1, which is hereinafter referred to as “a first surface of the fixing unit 3”) is Wb3, and the width of the substrate 10 is W10, the relationship of Wb3>W10 is satisfied. Therefore, at a stage prior to assembling housing parts 1 and 2, at least one of the two fixing units 3 is not in contact with the substrate 10.

The support unit 4 of the housing part 1 has, for example, a trapezoidal cross-sectional surface. When the housing parts 1 and 2 are combined, the support unit 4 is arranged on each of the left and right side so that its distal end is positioned to contact the surface of the fixing unit 3 facing the side surface of the housing part 2 (in FIG. 3, a surface indicated by reference symbol P32, which is hereinafter referred to as “a second surface of the fixing unit 3”). Specifically, the support units 4 are arranged in a manner that satisfies the following relationship:

Wbo3<Wti4<Wto3

Here,
Wbo3 is a width between the inner side surface of the housing part 2 (a surface indicated by P2_1 in FIG. 3, which is hereinafter referred to as “a first surface of the housing part 2”) and the bottom part of the second surface of the fixing unit 3 P3_2;
Wti4 is a width between the inner side surface of the housing part 1 (a surface indicated by P1_1 in FIG. 3) and the distal end part of the first surface of the support unit 4 (a surface indicated by P4_1 in FIG. 3), or a width between the first surface of the housing part 2 P2_1 and the first surface of the support unit 4 P4_1 when assembling the housing parts 1 and 2, and;
Wto3 is a width between the first surface of the housing part 2 P2_1 and the distal end part of the second surface of the fixing unit 3 P32.

Furthermore, the support unit 4 is tall enough for its distal end part to come in contact with the fixing unit 3 when combining the housing parts 1 and 2.

Therefore, when combining the housing parts 1 and 2, the two support units 4 on the left and right sides as illustrated come in contact with the second surface of the fixing unit 3 P3_2 and push the fixing unit 3 towards the substrate 10. In this manner, each of the two fixing units 3 on the left and right side deforms towards the substrate 10 and come in contact with the substrate 10. In the example after assembly in FIG. 3, the two deformed left and right fixing units 3 are each in contact with corner portions defined by the side surface and the upper surface of the substrate 10, in a manner that the substrate 10 is clamped from both sides and held down. As a result, the left and right positions of the substrate 10 are fixed, and the upper and lower positions are also fixed by being held down on the pedestal 5. The fixing units 3 are tall enough to come in contact with the substrate 10 when being deformed.

The matter of fixing the front and back positions of the substrate 10 will be explained below. As shown in FIG. 4, the housing part 2 has a fixing unit 3 also at the back of the substrate 10, and the housing part 1 has a support unit 4. The positional relation between the fixing unit 3 and the support unit 4 in this case is the same as that explained in FIG. 3. The housing part 2 has an L-shaped area L1, which is obtained by bending the front end portion of the housing part 2 inwards towards the inner housing part. When combining the housing parts 1 and 2, the front and back positions of the substrate 10 are fixed in a manner that the front surface thereof comes in contact with the area L1, and the back surface thereof (or a corner portion) comes in contact with the deformed fixing unit 3.

After the housing parts 1 and 2 are combined, the sealing member 20 is inserted from the rear of the housing in order to seal the rear of the housing. Although not shown in the present example, a strap hole may be formed on the sealing member 20.

### 1.2 Effects of Present Embodiment

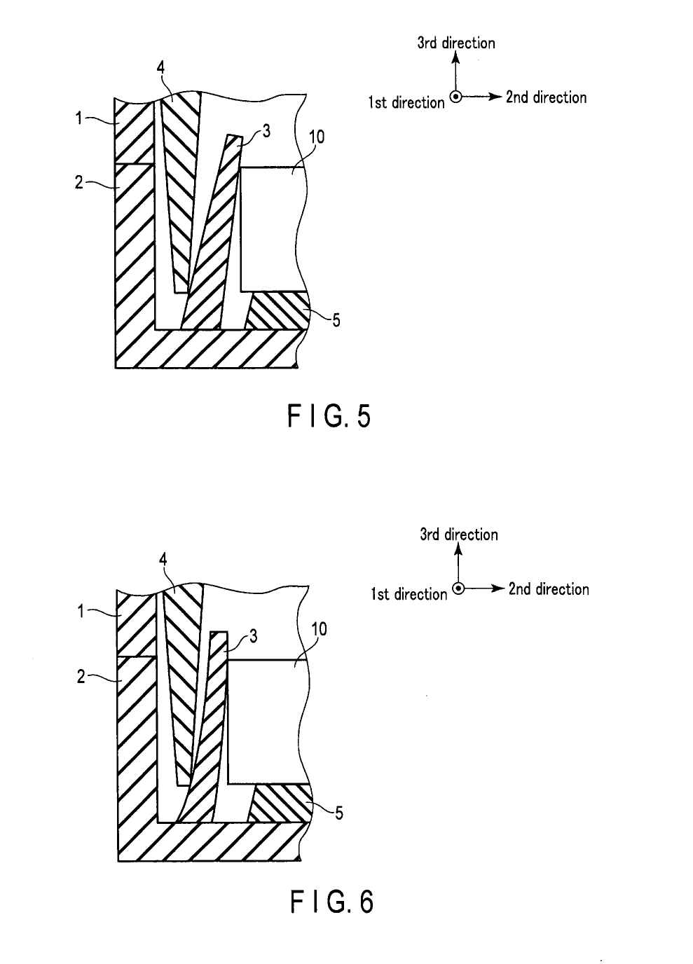

According to the configuration of the present embodiment, the substrate 10 may be fixed regardless of the variations in the dimensions of the housing or the substrate 10. In the following, the present effect will be explained based on an example in the case where the width of the substrate 10 varies. FIG. 5 and FIG. 6 are diagrams obtained by enlarging area C of FIG. 3. FIG. 5 shows a case in which the width of the substrate 10 is narrow, and FIG. 6 shows a case in which the width of the substrate 10 is wide. As shown in FIG. 5 and FIG. 6, even if the width of the substrate 10 varies, the fixing unit 3 is elastically deformed in accordance thereto, allowing the substrate 10 to be constantly held.

In this manner, the present embodiment is capable of fixing the substrate 10 inside the housing regardless of variation in the dimensions of each part by fixing the substrate 10 using the fixing unit 3.

### 2. Second Embodiment

A semiconductor storage device according to a second embodiment will be explained. The present embodiment relates to a structure for fixing the left, right, upper, and lower positions of the substrate 10 in the first embodiment. In the present embodiment, four examples are specifically shown. In the following, only the matters different from the first embodiment will be explained.

### 2.1 First Example

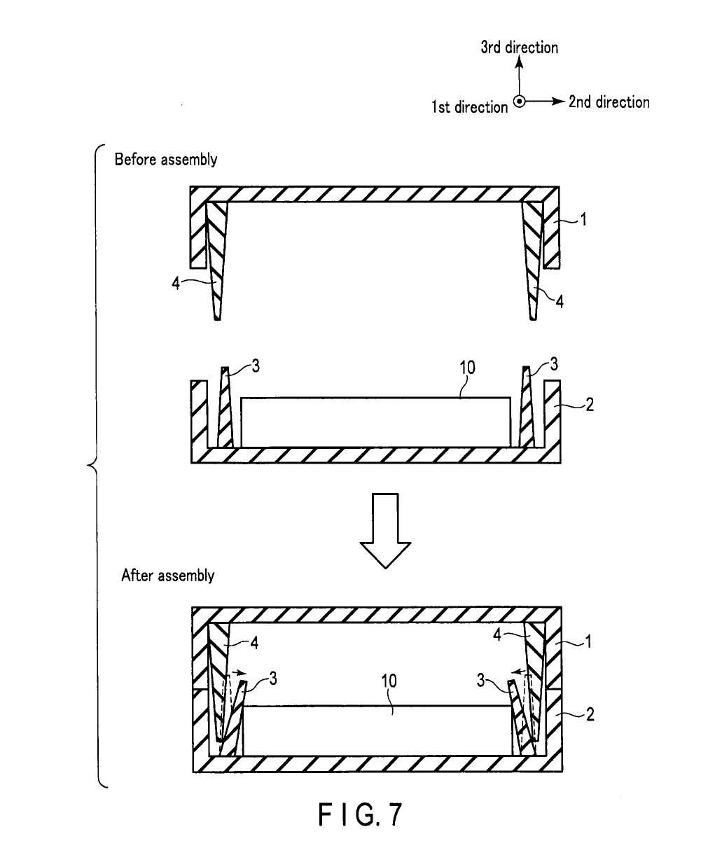

A configuration related to a first example of the present embodiment will be explained using FIG. 7. The present example does not include the pedestal 5 of the first embodiment. As illustrated, the pedestal 5 is not included in the present example. The left, right, upper, and lower positions of a substrate 10 are fixed by the left and right fixing units 3 and a bottom surface of inside a housing part 2.

### 2.2 Second Example

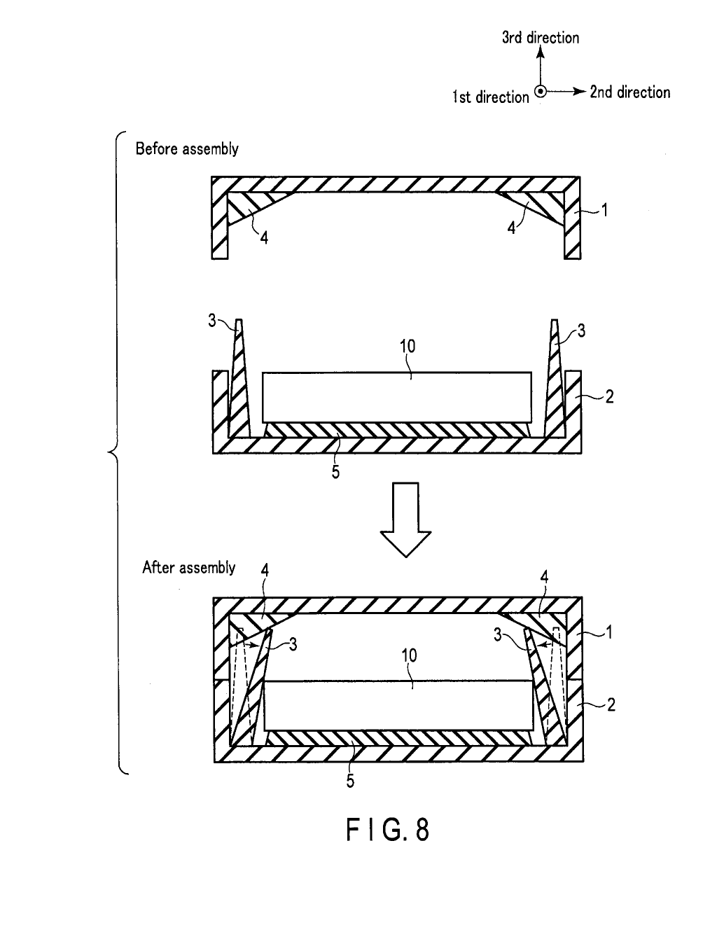

A configuration according to a second example of the present embodiment will now be explained using FIG. 8. In the present example, the support unit 4 in the first embodiment has a different structure. As illustrated, a support unit 4 in the present example is provided in the left and right corners inside the housing part 1 and has a triangular shape. A fixing unit 3 is tall enough for its distal end part to come in contact with the support unit 4 when the housing part 1 and 2 are combined. When assembling the housing, the fixing unit 3 comes in contact with this support unit 4 and deforms towards the substrate. As a result, the left, right, upper, and lower positions of the substrate 10 are fixed by the fixing unit 3 and the pedestal 5. In the present example, it is also fine to not include the pedestal 5.

### 2.3 Third Example

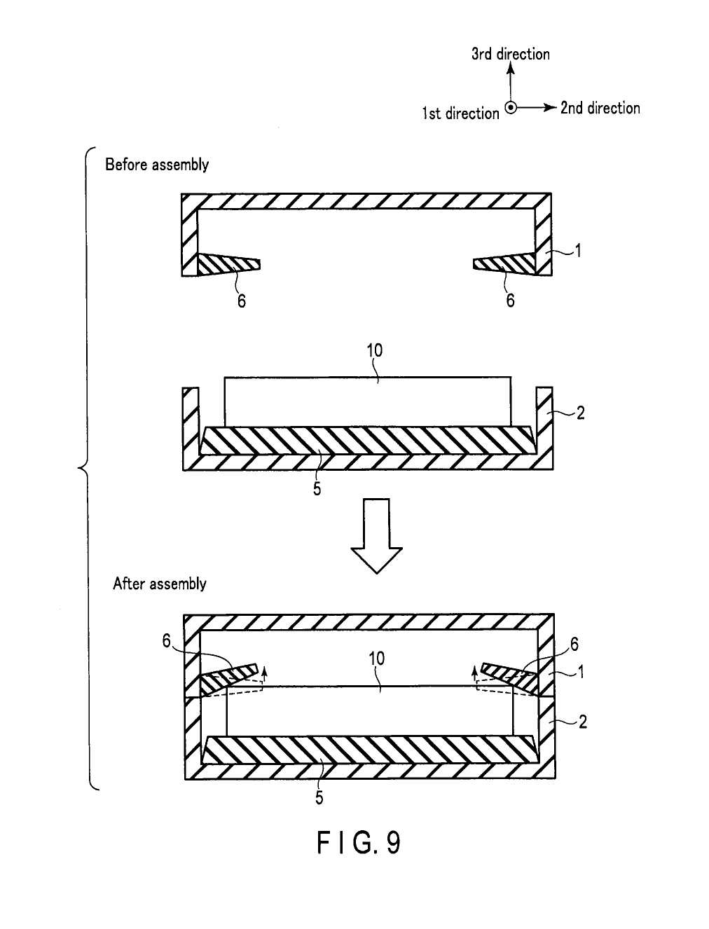

A configuration according to a third example of the present embodiment will now be explained using FIG. 9. In the present example, fixing units are provided on the side surfaces inside the housing part 1 of the first embodiment. As illustrated, fixing units 6 are provided on the left and right side surfaces of the housing part 1. The fixing units 6 are provided on the housing part 1 and are formed of, for example, insulating resin which has elasticity. When the housing is assembled, the fixing units 6 are arranged at positions which come in contact with the substrate 10. Accordingly, when the housing is assembled, the fixing units 6 are pushed by the substrate 10 and deformed. As a result, the left, right, upper, and lower positions of the substrate 10 are fixed by the fixing unit 6 and the pedestal 5. Therefore, in the present example, the support unit 4 corresponding to the fixing unit 6 has been removed. In the present example, the pedestal 5 may be removed.

### 2.4 Fourth Example

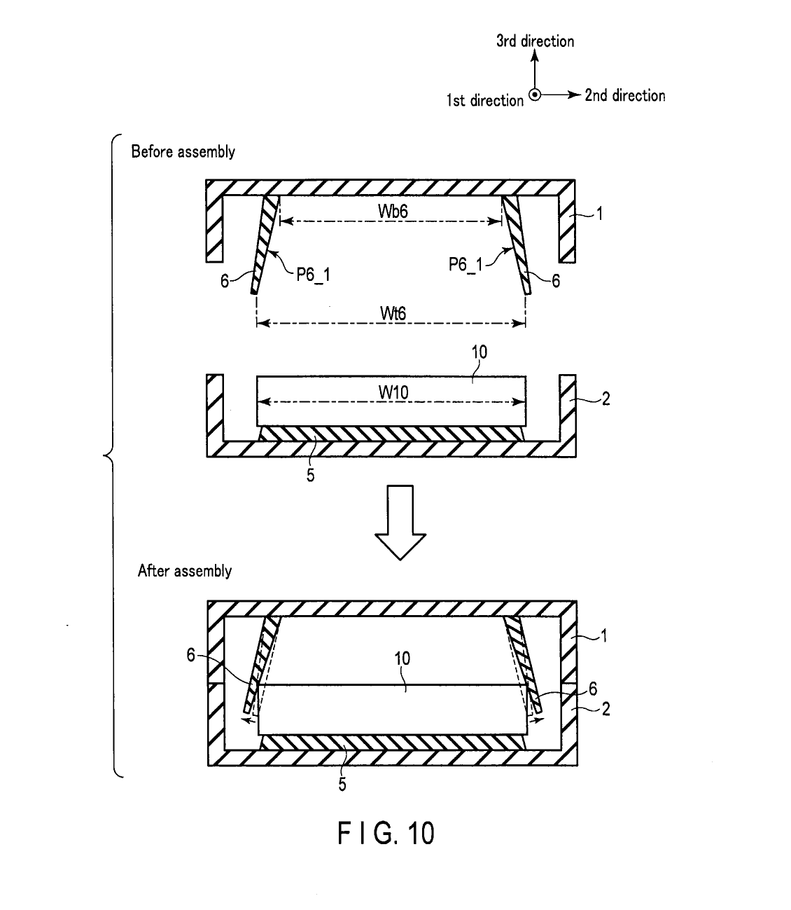

A configuration according to a fourth example of the present embodiment will now be explained using FIG. 10. In the present example, fixing units are provided on the bottom surface inside the housing part 1 of the first embodiment. As illustrated, in the inner side of the housing part 1, the fixing unit 6 is arranged on each of the left and right sides of the bottom surface. The relationship between the spacing of the two fixing units 6 and a width W10 of the substrate 10 satisfies the following relationship:

Wb6<W10<Wt6

Here,
Wb6 is the spacing of the bottom part between the surfaces of two fixing units 6 facing each other (a surface indicated by P6_1 in FIG. 10, hereinafter referred to as “a first surface of fixing unit 6”);
W10 is the width of the substrate 10; and
Wt6 is the spacing between the distal end parts of the first surfaces of two fixing units 6.

The fixing units 6 are tall enough to come in contact with the substrate 10 when the housing is assembled. Accordingly, when the housing is assembled, the fixing units 6 are pushed by the substrate 10 and deformed. As a result, the left, right, upper, and lower positions of the substrate 10 are fixed by the fixing unit 6 and the pedestal 5. Therefore, in the present example, the support unit 4 corresponding to the fixing unit 6 has been removed. In the present example, the pedestal 5 may also be removed.

### 2.5 Effects of Present Embodiment

The configuration according to the present embodiment is also capable of exercising the same effect as the first embodiment.

### 3. Third Embodiment

A semiconductor storage device according to a third embodiment will be explained. The present embodiment relates to a structure for fixing the front and rear positions of the substrate 10 of the first and second embodiments. In the present embodiment, three examples are specifically given. In the following, only the matters different from the first embodiment will be explained.

### 3.1 First Example

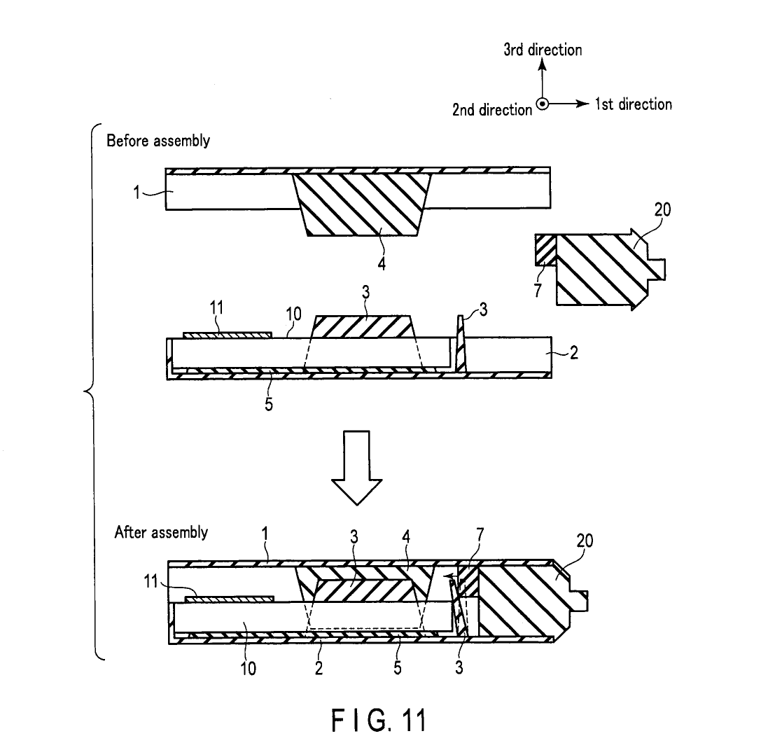

A configuration related to a first example of the present embodiment will be explained using FIG. 11. In the present example, the sealing member 20 of the first embodiment includes a support unit. As illustrated, the sealing member 20 includes a support unit 7. The support unit 7 is provided on the sealing member 20 and is formed of, for example, an insulating resin. When the housing is assembled, the support unit 7 pushes the fixing unit 3 at the back of the substrate 10 towards the substrate, causing it to deform and come in contact with the substrate 10. As a result, the front and rear positions of the substrate 10 are fixed by an L part formed at the front of the housing part 2 and the fixing unit 3 at the back of the substrate 10.

### 3.2 Second Example

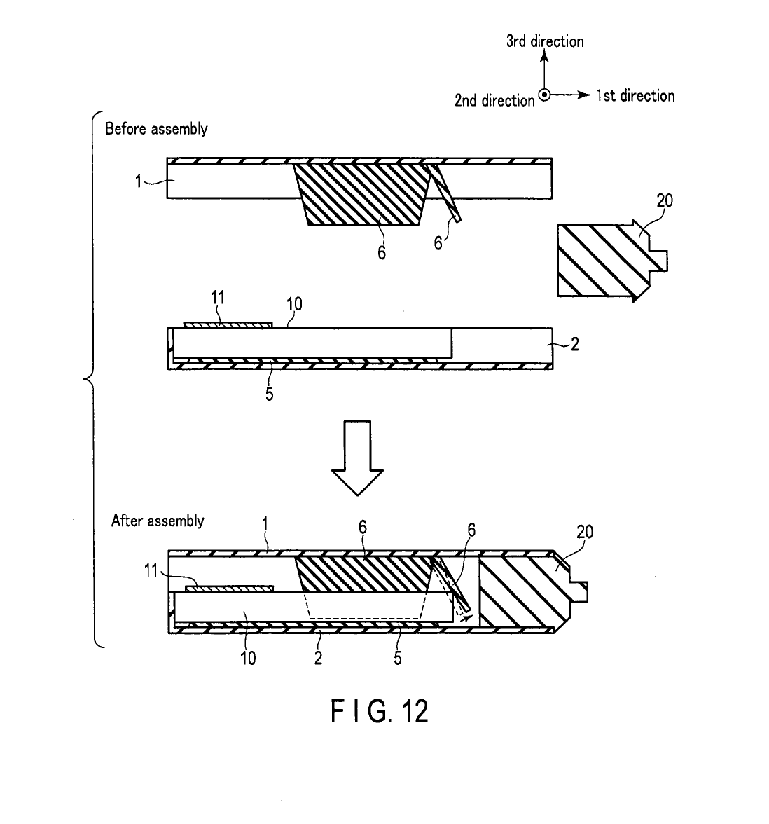

A configuration according to a second example of the present embodiment will now be explained using FIG. 12. In the present example, in the same manner as the fourth example of the second embodiment, a housing part 1 has a fixing unit 6 which comes in contact with the back of a substrate 10. As illustrated, the front and rear positions of the substrate 10 are fixed by an L part formed at the front of a housing part 2 and a fixing unit 6 at the back of the substrate 10. Therefore, in the present example, a support unit 4 corresponding to the fixing unit 6 has been removed.

### 3.3 Third example

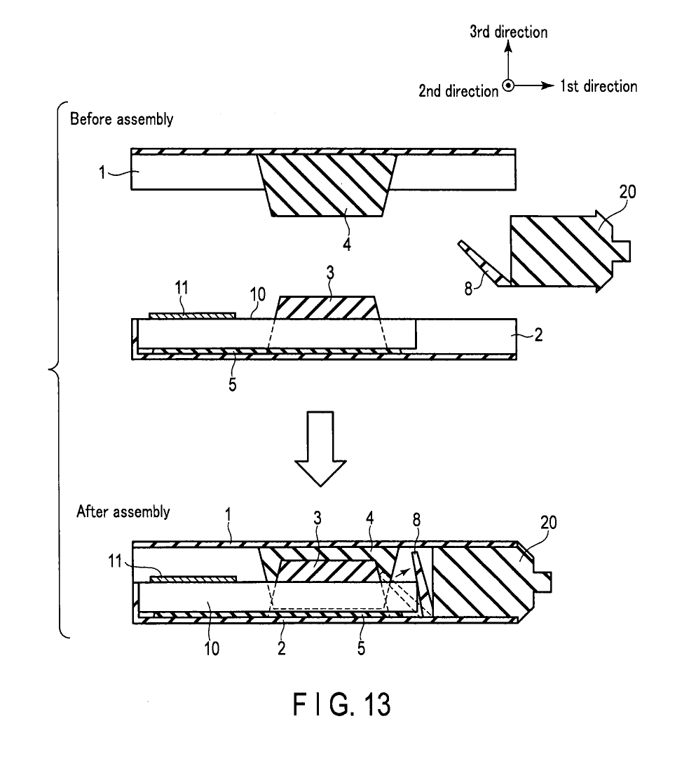

A configuration according to a third example of the present embodiment will now be explained using FIG. 13. In the present example, the sealing member 20 of the first embodiment includes a fixing unit. As illustrated, the sealing member 20 includes a fixing unit 8. The fixing unit 8 is provided on the sealing member 20 and is formed of, for example, insulating resin which has elasticity. When assembling the housing, the fixing member 8 comes in contact with a substrate 10 and deforms. As a result, the front and rear positions of the substrate 10 are fixed by an L part formed at the front of the housing part 2 and the fixing unit 8 at the back of the substrate 10. Therefore, in the present example, a support unit 4 corresponding to the fixing unit 8 has been removed.

### 3.4 Effects of Present Embodiment

The configuration according to the present embodiment is also capable of exercising the same effect as the first and the second embodiments.

In the present embodiment, the pedestal 5 may also be removed.

### 4. Modified Example, etc.

The semiconductor storage device according to the above embodiments includes a substrate (10 in FIG. 2) and a housing (FIG. 2). The substrate includes a memory capable of storing data and a controller controlling the memory. The housing includes first and second housing parts (1 and 2 in FIG. 3) and holds the substrate therein. The first housing part (2 in FIG. 3) includes a fixing unit (3 in FIG. 3) which has elasticity and is in contact with the substrate.

The above embodiments provide a semiconductor storage device which is capable of fixing the substrate 10 inside the housing.

The above embodiments are only examples. Therefore, each embodiment can be variously modified. Furthermore, each of the embodiments can be combined to every possible extent.

### 4.1 First Modified Example

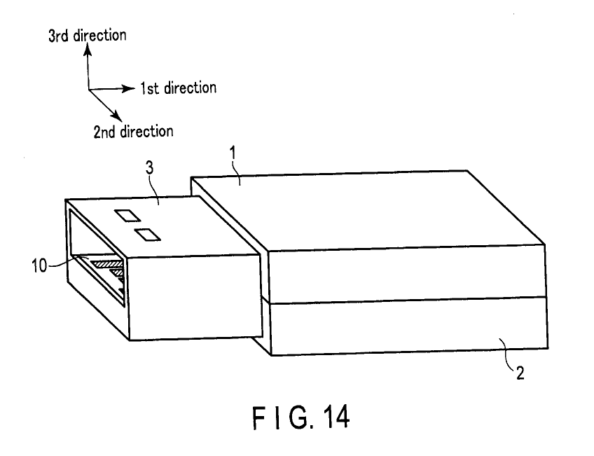

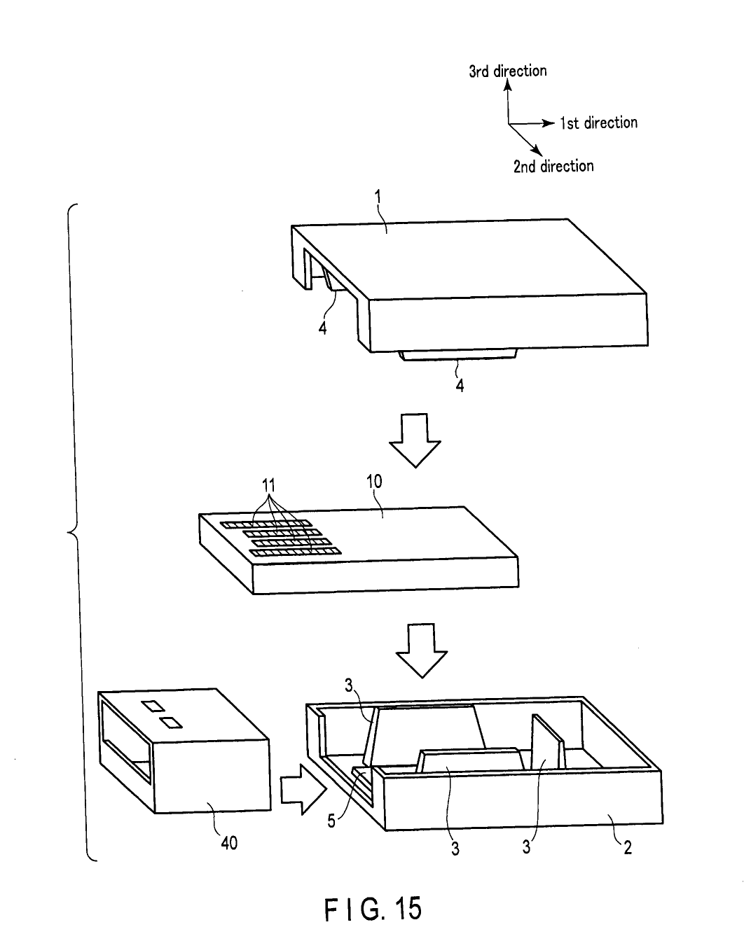

A first modified example is explained below. In the above embodiments, the configuration of the USB memory device may vary. FIG. 14 and FIG. 15 are a perspective view of the USB memory device according to the present example, and an exploded view of the USB memory device. As illustrated, the USB memory device in the present example includes a substrate 10, housing parts 1 and 2, and an insertion part 40. The insertion part 40 is formed of, for example, metal, and is inserted into a USB port of an external device. In the present example, since the housing parts 1 and 2 have shapes that seal the rear of the USB memory device when being combined, a sealing member 20 is not used. Furthermore, it is also fine to not include the insertion part 40 if the housing parts 1 and 2 form a shape that can be inserted into the USB port.

### 4.2 Other Modified Examples

In the above embodiments, in order to fix the left and right positions of the substrate 10, the fixing units 3 or 6 have been arranged on the left and right sides of the substrate 10. However, it is also fine to arrange the fixing unit only on the right side or the left side of the substrate 10. In such case, it is fine to have the left and right positions fixed by a side surface of the housing part 2 and the fixing unit 3 or 6.

Furthermore, the fixing units 3, 6, and 8 do not have to come in contact with the corner portion of the substrate 10, and instead, may come in contact with the side surface or the upper surface of the substrate 10.

Furthermore, the fixing unit 3, the support unit 4, the pedestal 5, the fixing unit 6, the support unit 7, and the fixing unit 8 may be formed by processing a part of the housing parts 1 and 2 and the sealing member 20, or may be provided as separate parts.

Furthermore, the fixing unit 3, the support unit 4, the fixing unit 6, the support unit 7, and the fixing unit 8 do not have to be in a trapezoidal shape, and may be, for example, rectangular, triangular, or cylindrical. Therefore, the shape is not limited.

Furthermore, the number of pieces of the fixing unit 3, the support unit 4, the fixing unit 6, the support unit 7, and the fixing unit 8 arranged on the left, right, and back of the substrate may be more than two, and therefore is not limited. For example, the shape of the fixing unit 3 arranged on the housing part 2 in the first embodiment may be cylindrical, and a plurality of the fixing units 3 may be respectively placed on the left and right sides and at the back of the substrate.

Furthermore, in the present example, an example of a trapezoidally-shaped pedestal 5 was explained. However, the shape is not limited. The number of pedestals 5 is not limited to one. The pedestal 5 may be omitted. In other words, the back surface of the substrate 10 may come in contact with the housing part 2.

Furthermore, in the present example, the terminal 11 is provided on the surface of the substrate 10. However, the terminal 11 may also be such that the entire terminal is embedded in the substrate 10, and the surface of the terminal 11 is exposed. In this case, the upper surface of the terminal 11 is flush with the upper surface of the substrate 10. Alternatively, the terminal 11 may also be such that a part including the bottom surface thereof is embedded in the substrate 10, and the upper surface is exposed. In such case, the upper surface of the terminal 11 will protrude from the upper surface of the substrate 10.

Furthermore, on the front end portion of the bottom surface of the housing part 2 an L-shaped portion L1 is formed. However, the shape is not limited to an L-shape as long as the substrate 10 is fixed and is prevented from falling out forward. For example, a groove may be formed on the side surface of the substrate 10, and a convex portion that matches the groove of the substrate 10 may be formed on the side surface of the housing part 2, to prevent the substrate 10 from falling out forward by fitting the convex portion in the groove. For example, a hole may be machined on the substrate 10, and a protrusion may be formed on the housing part 1 or 2 to penetrate the hole on the substrate 10.

Furthermore, the substrate 10 has a shape which is narrow at the back in the first embodiment, or is rectangular when observed from the upper surface in the first modified example. However, in the present example, the shape of the substrate 10 is not limited to these.

Furthermore, by forming the housing parts 1 and 2 in a shape that seals the back of the USB memory device, the sealing member 20 may be dispensed with.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A semiconductor memory device comprising:
a substrate including a memory capable of storing data and a controller controlling the memory; and
a housing including first and second housing parts and holding the substrate therein,
wherein the first housing part includes a fixing unit which has elasticity and is in contact with the substrate.

2. The device according to claim 1, wherein the fixing unit includes first and second fixing units,
in a state where the first and the second housing parts are separated, both the first and the second fixing units are not in contact with the substrate, and
in a state where the first and the second housing parts are combined, both the first and the second fixing units are in contact with the substrate.

3. The device according to claim 1, wherein the fixing unit is in contact with a corner portion of a side surface and an upper surface of the substrate.

4. The device according to claim 1, wherein the second housing part includes a support unit, and
the support unit is in contact with a surface on an opposite side of a surface where the fixing unit is in contact with the substrate.

5. The device according to claim 1, further comprising a first member sealing a part of the housing,
wherein a part of a first end portion of the housing is opened, the first end portion being connectable to an external device, and
a part of the first member is inserted in a second end portion which is opposite to the first end portion.

6. The device according to claim 1, wherein the housing further includes a pedestal holding the substrate,
the fixing unit includes first and second fixing units, and
the substrate is in contact with the first and the second fixing units and the pedestal.

7. The device according to claim 1, wherein the fixing unit includes first and second fixing units, and
a distance between the first fixing unit and the second fixing unit in the first housing part is larger than a width of the substrate disposed between the first fixing unit and the second fixing unit.

8. The device according to claim 1, wherein the fixing unit includes first and second fixing units, and
a distance between the first fixing unit and the second fixing unit in the first housing part is narrower than a width of the substrate disposed between the first fixing unit and the second fixing unit, and a distance between distal ends of the first fixing unit and the second fixing unit is wider than the width of the substrate.

9. The device according to claim 1, wherein the fixing unit is in contact with the substrate and fixes a position of the substrate inside the housing.

10. The device according to claim 1, wherein the first fixing unit deforms and is in contact with the substrate.

11. The device according to claim 1, wherein the first fixing unit is formed of resin.

12. The device according to claim 1, wherein the device is a USB memory device.

13. The device according to claim 1, wherein the substrate is a printed circuit board (PCB).

14. The device according to claim 1, wherein the memory and the controller are included in different semiconductor chips, and the semiconductor chips are included in a package as an SiP (system in a package).

15. The device according to claim 3, wherein the fixing unit includes first and second fixing units,
the first fixing unit is in contact with a first corner portion of a first side surface and the upper surface, the first side surface being a side surface of the substrate, and
the second fixing unit is in contact with a second corner portion of a second side surface and the upper surface, the second side surface being a side surface of the substrate, the second side surface facing the first side surface.

16. The device according to claim 3, wherein
a side surface of an end portion opposite the corner portion on the upper surface of the substrate is in contact housing.

17. The device according to claim 5, wherein the first member includes a support unit, and
the support unit is in contact with a surface on an opposite side of a surface where the fixing unit is in contact with the substrate.

18. The device according to claim 5, wherein the first member includes a first fixing unit which has elasticity,
a third side surface is in contact with the first end portion, the third side surface being a side surface of the substrate, and
a third corner portion of a fourth side surface and an upper surface is in contact with the first fixing unit, the fourth side surface being a side surface of the substrate, the fourth side surface facing the third side surface.

19. The device according to claim 6, wherein the first housing part further includes the pedestal.

20. The device according to claim 6, wherein the second housing part further includes the pedestal.
